(19) United States
(12) Patent Application Publication
(10) Pub. No.: US 2026/0238895 A1
(43) Pub. Date: Aug. 13, 2026

(54) SIGNAL PROCESSING CIRCUIT, SIGNAL PROCESSING METHOD, AND PROGRAM

(71) Applicant: Sony Interactive Entertainment Inc., Tokyo (JP)

(72) Inventors: Masayoshi Mizuno, Tokyo (JP); Kiyotsugu Arai, Kanagawa (JP)

(21) Appl. No.: 19/154,685

(22) PCT Filed: Feb. 16, 2023
(86) PCT No.: PCT/JP2023/005530

§ 371 Date: Aug. 7, 2025

(51) Int. Cl. H04N 25/60; H04N 25/47

(52) U.S. Cl. CPC H04N 25/60; H04N 25/47

(57) ABSTRACT

Provided is a signal processing circuit that processes an event signal generated by an EVS. The signal processing circuit includes a memory for storing a program code and a processor for executing operation in accordance with the program code. The operation includes detecting, in each of blocks which are split sections of a detection region of the EVS, a relation between positions of the event signals included in the block, in accordance with a result representing a distribution of at least the positions or times of the event signals with use of a Gaussian mixture model.

### TECHNICAL FIELD

The present invention relates to a signal processing circuit, a signal processing method, and a program.

### BACKGROUND ART

An event-based vision sensor (EVS) in which pixels time-asynchronously generate signals upon detecting a change in the intensity of incident light has been known. An EVS is also called an event driven sensor (EDS), an event camera, or a dynamic vision sensor (DVS), and includes a sensor array constituted by sensors including light reception elements. An EVS generates an event signal including a time stamp, sensor identification information, and polarity information regarding brightness changes when a sensor detects an intensity change in incident light, or more specifically, a brightness change on a surface of an object. Over a frame-based vision sensor which scans all pixels every predetermined cycle, or specifically, an image sensor such as a charge coupled device (CCD) or a complementary metal oxide semiconductor (CMOS), the EVS has an advantage in the low-power and high-speed operability. For example, PTL 1 and PTL 2 disclose technologies related to such an EVS.

### CITATION LIST

### Patent Literature

[PTL 1]
Japanese Translations of PCT for Patent No. 2014-535098
[PTL 2]
Japanese Patent Laid-Open No. 2018-85725

### SUMMARY

### Technical Problems

However, since knowledge about techniques, as processing on signals generated by a vision sensor, for use in a frame-based vision sensor has been accumulated, there is a tendency to convert even event signals generated by the EVS into a bitmap or a two-dimensional form and perform processing thereon. In this case, the processing is performed after redundant information is added to event signals that are generated in a time-asynchronous manner. The high-speed operability of the EVS has not been in sufficiently effective use.

In view of this, an object of the present invention is to provide a signal processing circuit, a signal processing method, and a program by which event signals generated by an EVS can be processed at higher speed.

### Solution to Problems

A certain aspect of the present invention provides a signal processing circuit that processes an event signal generated by an EVS and that includes a memory for storing a program code and a processor for executing operation in accordance with the program code. The operation includes detecting, in each of blocks which are split sections of a detection region of the EVS, a relation between positions of the event signals included in the block, in accordance with a result representing a distribution of at least the positions or times of the event signals with use of a Gaussian mixture model.

Another aspect of the present invention provides a signal processing method for processing an event signal generated by an EVS, the method including, through operation that is executed by a processor in accordance with a program code stored in a memory, detecting a relation between positions of the event signals generated in each of blocks which are split sections of a detection region of the EVS, in accordance with a result representing a distribution of at least the positions or generation times of the event signals in the block with use of a Gaussian mixture model.

Still another aspect of the present invention provides a program for processing an event signal generated by an EVS. Operation that is executed by a processor in accordance with the program includes detecting a relation between positions of the event signals generated in each of blocks which are split sections of a detection region of the EVS, in accordance with a result representing a distribution of at least the positions or generation times of the event signals in the block with use of a Gaussian mixture model.

### BRIEF DESCRIPTION OF DRAWINGS

FIG. 1 is a diagram schematically depicting a configuration of a signal processing circuit according to one embodiment of the present invention.

FIG. 2 is a schematic diagram depicting an example of blocks and events.

FIG. 3 is a diagram for illustrating an example of detecting a line segment in the examples depicted in FIGS. 1 and 2.

FIG. 4 is a diagram depicting an example of representing a distribution of positions of event signals with use of a Gaussian mixture model.

FIG. 5 is a diagram depicting an example of detecting a line segment in accordance with parameters of a cluster that are identified in a Gaussian mixture model.

FIG. 6 is a diagram depicting an example of representing a distribution of times of event signals with use of a Gaussian mixture model.

FIG. 7 is a diagram depicting an example of representing a distribution of times of event signals with use of a Gaussian mixture model.

FIG. 8 is a diagram depicting an example of representing a distribution of times of event signals with use of a Gaussian mixture model.

FIG. 9 is a diagram depicting another example of detecting a figure formed by a set of positions of event signals.

FIG. 10 is a diagram for illustrating a process example using parameters indicating the positional relation among event signals in a block.

### DESCRIPTION OF EMBODIMENT

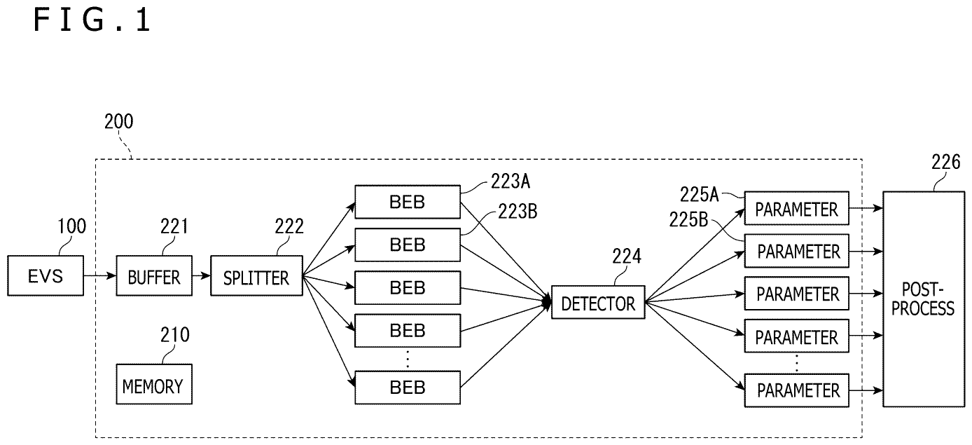

FIG. 1 is a diagram schematically depicting a configuration of a signal processing circuit according to one embodiment of the present invention. A signal processing circuit 200 that processes an event signal generated by an EVS 100 includes a processing circuit(s) such as a central processing unit (CPU), a digital signal processor (DSP), an application specific integrated circuit (ASIC), and/or an field-programmable gate array (FPGA), for example. The signal processing circuit 200 includes a memory 210 including various types of read only memories (ROMs) and/or random access memories (RAMs), for example. In accordance with a program code stored in the memory 210, the signal processing circuit 200 executes operation which will be described later. It is to be noted that a post-process 226 may be executed partially or completely in the signal processing circuit 200, or may be executed in a device or circuit separate from the signal processing circuit 200.

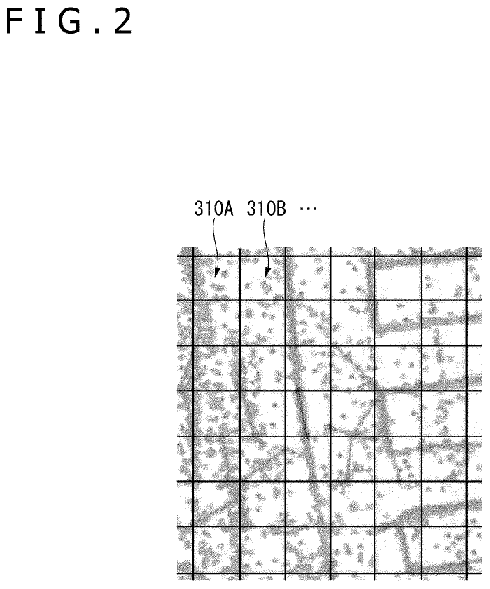

Event signals generated by the EVS 100 are temporarily held in a buffer 221, and are allocated into block event buffers (BEBs) 223A, 223B, (hereinafter, also collectively referred to as BEBs 223) by a splitter 222. Here, the splitter 222 allocates event signals generated in respective blocks 310A, 310B, . . . (hereinafter, also collectively referred to as blocks 310) which are, for example, split lattice-like sections of the detection region of the EVS 100 as depicted in FIG. 2, to the corresponding BEBs 223A, 223B, The BEB 223 is defined in advance as a buffer for temporarily holding an event signal of the corresponding lattice-like block 310 which is a split section of the detection region of the EVS 100. In a case where setting of the blocks 310 is dynamically changed as in an example described later, the definition of the BEB 223 is also dynamically changed in accordance with the setting of the blocks 310. Each event signal includes information regarding, for example, a position x, y in the detection region, and may further include information regarding a generation time t. By referring to the information indicating the position x, y, the splitter 222 determines which BEB 223 the event signal is allocated to. The splitter 222 may replicate an event signal, and allocate the event signals to two or more BEBs 223, as in an example described later.

In each BEB 223, an event signal generated in the corresponding block 310 is held. When an event signal is allocated to any one of the BEBs 223A, 223B, . . . , the detector 224 detects a line segment from a set of the positions x, y of the event signals held in the corresponding BEB 223. In the present embodiment, line segment detection by the detector 224 is an example of detecting an intra-block positional relation of event signals generated in the block 310. By way of example, in a case where an event occurs upon movement of an edge of an object in a certain block 310, a line segment is formed by a set of the positions x, y of event signals. An edge of the object is not necessarily a straight line, but, when the lattice-shaped block 310 is set to a suitable size, the edge of the object can be approximated as a set of line segments. It is to be noted that the “positional relation of event signals” herein means data in which the positions of event signals in a block is expressed with a lighter load than on a bitmap. Therefore, an example of detecting an intra-block positional relation of event signals is not limited to detection of a line segment or a straight line, and may include detection of a certain figure that is defined by a finite number of parameters, for example.

It is to be noted that, as described later, the detector 224 detects a line segment in accordance with a result representing a distribution of at least the positions x, y or the times t of event signals in each block with use of a Gaussian mixture model. In the following example, only a straight line whose start point and end point are not identified can directly be detected. A straight line is limited to a section in the block 310, whereby a line segment corresponding to the straight line is detected. The detector 224 may detect a plurality of line segments in one block 310 by using a Gaussian mixture model. The detector 224 may detect a curved line or any other figure from a set of the positions x, y of event signals by using a Gaussian mixture model, as in an example described later.

More specifically, the detector 224 outputs parameters 225A, 225B, . . . (hereinafter, also collectively referred to as parameters 225) each indicating a detected line segment. The parameter 225A is information indicating a line segment detected by the detector 224 from event signals generated in the block 310A and held in the BEB 223A. This similarly applies to the parameter 225B and subsequent parameters. It is to be noted that the parameters 225A, 225B, . . . are not necessarily synchronously outputted, and are outputted asynchronously by a process that is executed by the detector 224 when an event signal is allocated to any one of the BEBs 223 in the above-described manner. The outputted parameters 225 are used, in the post-process 226, as information indicating a detection result of the EVS 100. As the post-process 226, a process of detecting a movement of a subject, three-dimensional shape matching to a subject, a recognizer process using machine learning, or the like is executed, for example.

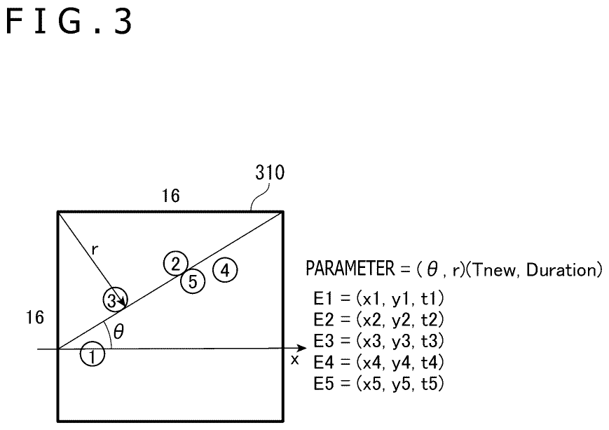

FIG. 3 is a diagram for illustrating an example of detecting a line segment in the example depicted in FIG. 1. In the present embodiment, when the event signals are allocated to the BEBs 223 corresponding to the lattice-shaped blocks 310 which are split sections of the detection region of the EVS 100 in the above-described manner, the detector 224 executes a process of detecting a line segment from a set of the positions x, y of the event signals. The example in FIG. 3 schematically indicates a process of detecting a line segment in a case where five event signals are in the BEB 223 (the actual number of event signals may be greater or less than five). Event signals E1 to E5 may include, as information, positions x1 to x5, y1 to y5 in the detection region and include, as information, generation times t1 to t5. The positions x1 to x5, y1 to y5 each represent a position in the process target block 310. If the size of the block 310 (16-pixel×16-pixel in the depicted example) is appropriate, bitmapping event information is not required. The detector 224 can mathematically detect a line segment from the positions x1 to x5, y1 to y5 of the event signals E1 to E5 held in the BEB 223.

Here, for the line segment detection by the detector 224, an upper limit of the number of event signals held in the BEB 223 may be set, and the oldest event signal may be deleted when a new event signal is allocated, by the FIFO (First In, First Out) method, for example. Alternatively, a threshold may be set for the difference between the time t of a certain event signal and a process time or the time t of the latest event signal such that an event signal that has the difference exceeding the threshold is not used for the line segment detection by the detector 224 or is deleted from the BEB 223.

In addition, in a case where a new event signal of the same position x, y as that of an event signal that has been held in the BEB 223 is allocated, the time t of the held event signal may be updated to the time t of the new allocated event signal, for example, to avoid an overlap of event signals in the same position x, y in the BEB 223. In this case, since preventing an overlap of event signals in the same position x, y is a prerequisite, the speed of arithmetic for detecting a line segment can be increased, for example. In another example, a plurality of event signals of the same position x, y and different times t may be held in the BEB 223.

In the above example depicted in FIG. 3, the detector 224 outputs parameters including an angle (θ), a distance (r), a latest event time (Tnew), and event duration time (Duration). The angle (θ) represents a gradient of the line segment with respect to the x axis. The distance (r) represents a distance (the length of a perpendicular) from the upper left corner of the block to the line segment. However, this is a non-limitative example, and any line segment can be identified by another known method (for example, with use of two parameters representing a gradient of the line segment and a relative position of the line segment with respect to the block). The latest event time (Tnew) represents a time corresponding to the latest one of event signals used for line segment detection. The latest event time (Tnew) may be identified by, for example, extracting the latest one of the times t1 to t5 of the event signals E1 to E5 used for the line segment detection (Tnew=t5 in the example in FIG. 3). Alternatively, an output time of the parameter 225 from the detector 224 or a reception time of the parameter 225 at the post-process 226 may be determined as the latest event time (Tnew), without referring to the times of the event signals E1 to E5, because the line segment detection is performed upon allocation of the latest event signal to the BEB 232.

Event duration time represents the difference between the earliest one and the latest one of the times t1 to t5 of the event signals E1 to E5 used for the line segment detection (that is, Duration=t5−t1 in the example in FIG. 3). From information regarding the event duration time, how long the time of occurrence of event signals that the detected line segment is based on is can be recognized. For example, in a case where the event duration time is significantly long, it may be determined that many event signals detected as noise are used in the line segment detection and, for example, the reliability of the line segment detected at the post-process 226 is low. In addition, the detector 224 may output a variance Var[t] of the generation times of event signals in terms of a time series order. In this case, in a case where the event duration time is long but the variance Var[t] is small, it can be determined that the reliability of a line segment detected at the post-process 226 is high. Further, in a case where the event duration time is long and the variance Var[t] is also large, it can be determined that the reliability of a detected line segment is low.

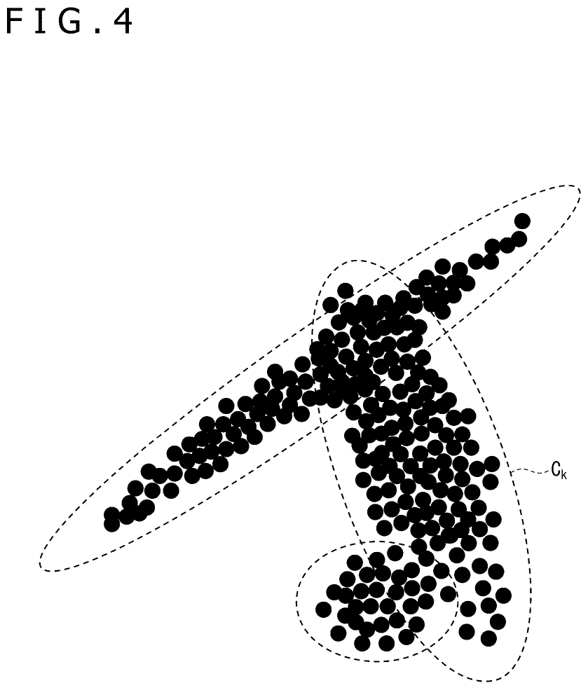

FIG. 4 is a diagram depicting an example of representing a distribution of positions of event signals with use of a Gaussian mixture model. In the present embodiment, the detector 224 detects a line segment in accordance with a result representing a distribution of at least the positions x, y or the times t of event signals in a block with use of a Gaussian mixture model, as previously explained. In the example depicted in FIG. 4, the positions x, y of event signals in a block are represented by a two-dimensional normal distribution with use of a Gaussian mixture model. Here, the Gaussian mixture model is a model that represents a probability density function with use of the sum of a plurality of normal distributions, as indicated by the following expression, for example. Parameters πₖ, μₖ, and Σₖ of a cluster Ck that represents each normal distribution can be estimated by, for example, an expectation-maximization (EM) algorithm.

$$p ( x ) = {\sum }_{k = 0}^{K - 1} {π}_{k} N ( x \vert {μ}_{k} , {\sum }_{k} ) \qquad [ Math . 1 ]$$

$$wherein 0 \leq {π}_{k} \leq 1 ,$$

$${\sum }_{k = 0}^{K - 1} {π}_{k} = 1$$

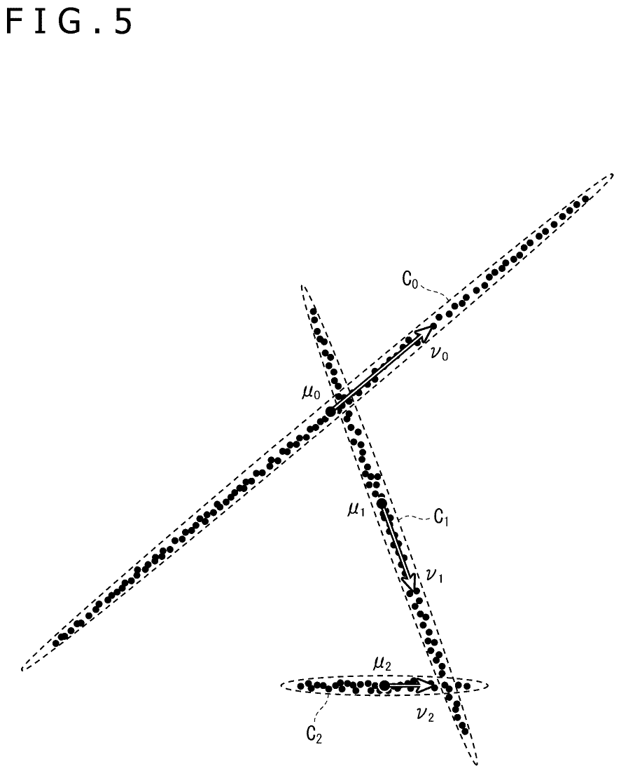

FIG. 5 is a diagram depicting an example of detecting a line segment in accordance with parameters of a cluster identified in a Gaussian mixture model. In a case where a distribution of positions of event signals in a cluster has a directivity as in the example depicted in FIG. 5, that is, in a case where the distribution is a two-dimensional normal distribution having a shape extended to one direction, parameters for representing a line segment formed by a set of positions of event signals can be calculated from parameters of the cluster identified in the Gaussian mixture model. Specifically, with regard to parameters μ₀ and Σ₀ of the cluster C₀ which are estimated from the above expression, μ₀ represents a mean of the distribution, and a vector v₀ which represents a long axis direction of the cluster C₀ is obtained by eigendecomposition of do. For example, to represent a line segment with use of the parameters θ and r depicted in FIG. 3, the gradient θ of the line segment can be identified from the vector v₀, and the distance r which indicates the position of the line segment can be identified from the parameter μ₀ which represents a mean of the distribution and the vector v₀. This similarly applies to clusters C₁ and C₂ depicted in FIG. 5 such that parameters θ and r of a line segment can also be identified from a vector v₁ and v₂ and a parameter μ₁ and μ₂.

To perform the line segment detection of the above example, the detector 224 estimates, for a distribution of positions of event signals in the BEB 223, parameters πₖ, μₖ, and Σₖ of a cluster Cₖ which is a two-dimensional normal distribution by using an EM algorithm. In a case where the distribution of positions of event signals in the cluster Cₖ has a directivity, that is, in a case where a variance of the positions in the long axis direction of the cluster Cₖ indicated by the vector vₖ is sufficiently greater than a variance of the positions in a short axis direction (which is perpendicular to the long axis direction) of the cluster Cₖ, the parameters 225 for representing a line segment are calculated in accordance with the parameters πₖ and Σₖ of the cluster Cₖ.

In the example having been explained with reference to FIG. 5, the process of detecting a line segment from a set of positions of event signals in each block by the detector 224 is completed by arithmetic of a Gaussian mixture model. In this case, calculation is executed in accordance with an algorithm, such as an EM algorithm, for estimating parameters of a Gaussian mixture model, while it is not necessary to comprehensively try parameters unlike, for example, line segment detection using Hough transform. Accordingly, the speed of the arithmetic can be increased to save the process resources in the signal processing circuit 200.

Further, in another example, as depicted in FIG. 4, parameters representing a line segment or any other figure of event signals in a cluster Cₖ identified in a Gaussian mixture model may be identified using such a method as Hough transform. Also in this case, event signals are processed in each cluster Cₖ, so that the arithmetic can be done at high speed, compared to arithmetic of every event signal in a block without identifying a cluster, for example. Accordingly, the process resources in the signal processing circuit 200 can be saved.

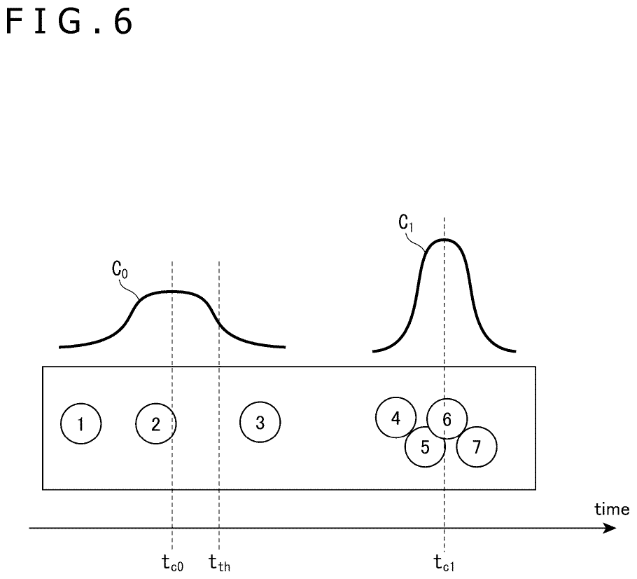

FIGS. 6 to 8 are diagrams each depicting an example of representing a distribution of times of event signals with use of a Gaussian mixture model. In each of the examples depicted in FIGS. 6 to 8, times t of event signals in a block are represented by a one-dimensional normal distribution with use of a Gaussian mixture model. For event signals in a cluster identified using a Gaussian mixture model that represents a distribution of times of the event signals, the detector 224 detects a line segment or any other figure by such a method as Hough transform or by another Gaussian mixture model that represents a distribution of positions of the event signals as in the example having been explained with reference to FIG. 5.

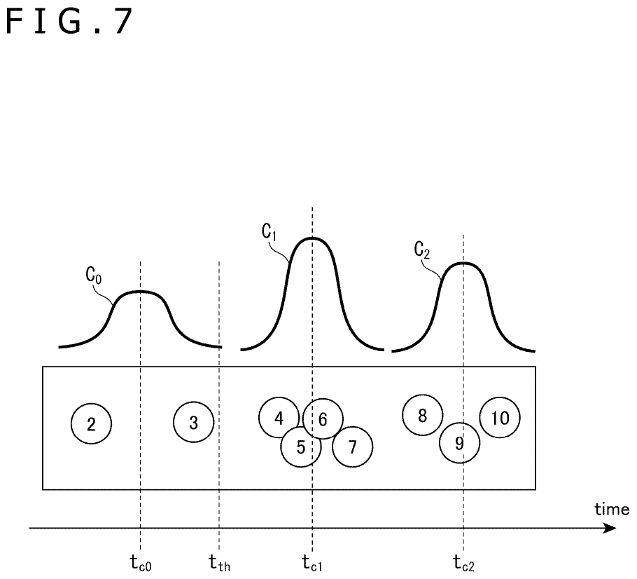

In the above example, in a case where the difference between a center of the time distribution in the cluster Cₖ and the process time or the time of the latest event signal is greater than a threshold, the detector 224 may refrain from using the event signals in the cluster Cₖ for line segment detection. Here, a center of the time distribution is calculated as a mean value or a gravity center of the times of the event signals in the cluster Cₖ, for example. In the examples in FIGS. 6 to 8, a time prior to the process time by a threshold is defined as a time tₜₕ. In the example in FIG. 6, event signals (nos. 1 to 3) in a cluster C₀ whose mean time value to of event signals in a normal distribution of the cluster C₀ is prior to the time tₜₕ are not used for line segment detection while event signals (nos. 4 to 7) in a cluster C₁ whose mean time value to is after the time tₜₕ are used for line segment detection. Similarly, in the example in FIG. 7, event signals (nos. 2 and 3) in the cluster C₀ whose mean time value to is prior to the time tₜₕ are not used for line segment detection while event signals (nos. 4 to 10) in the clusters C₁ and C₂ whose mean time values t_{c1} and t_{c2} are after the time tₜₕ are used for line segment detection.

In a case where event signals that are classified into a plurality of clusters are used for line segment detection as in the above example in FIG. 7, the detector 224 may perform line segment detection separately on event signals of one cluster and event signals of the other cluster, or may perform line segment detection collectively on the event signals of all the clusters to be used. In the example in FIG. 7, in a case where the former is adopted, line segment detection is performed separately on event signals (nos. 4 to 7) of the cluster C₁ and event signals (nos. 8 to 10) of the cluster C₂, and in a case where the latter is adopted, line segment detection is performed collectively on the event signals (nos. 4 to 10) of the clusters C₁ and C₂.

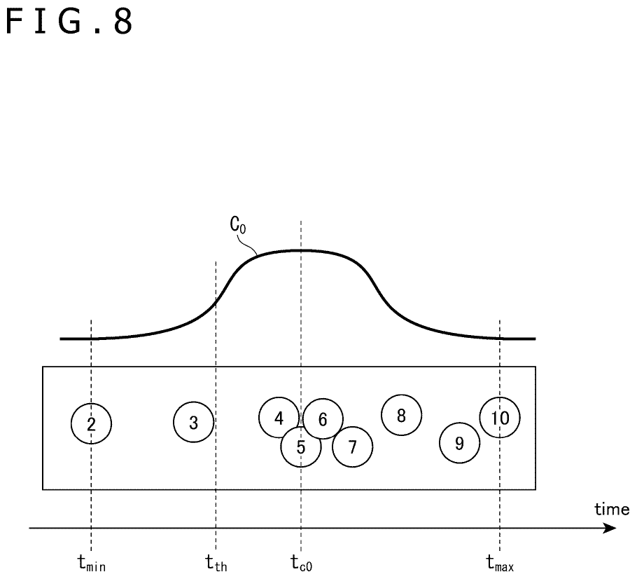

Further, in the above example, in a case where the length of distribution time of the event signals in the cluster Cₖ is greater than a threshold, the detector 224 may refrain from using the event signals in the cluster Cₖ for line segment detection. In the example in FIG. 8, a mean time stamp value t_{c0} of the cluster C₀ is after the time tₜₕ but the length of the distribution time of event signals (nos. 2 to 10) of the cluster C₀, that is, the difference between a minimum time value tₘᵢₙ and a time maximum value tₘₐₓ, is greater than a threshold. Thus, the detector 224 refrains from performing line segment detection on these event signals. It is to be noted that it is not necessary to use a minimum value and a maximum value of the times to calculate the length of distribution time. The length may be calculated as the length of a section in which a predetermined ratio or greater of data in a cluster is included, for example, a 2σ section or a 3σ section of a normal distribution.

In the examples having been explained with reference to FIGS. 6 to 8, line segment detection is performed for each cluster in a Gaussian mixture model that represents distributions of times of event signals included in each block. Accordingly, line segment detection can be executed separately for event signals occurring by, for example, each of a plurality of movements of a subject that have occurred separately in time, so that the arithmetic can be done at high speed, compared to arithmetic of every event signal in a block without identifying a cluster, for example. Accordingly, the process resources in the signal processing circuit 200 can be saved.

In addition, in a case where a determination to refrain from using the event signals in a cluster for line segment detection is made if the difference between a center of a time distribution in the cluster and the process time is greater than a threshold, event signals that are irrelevant to the latest movement of the subject and are highly likely to be noise can be removed from the detection process. Moreover, in a case where a determination to refrain from using the event signals in a cluster for line segment detection is made if the length of distribution time of the event signals in the cluster is greater than a threshold, event signals that are highly likely to be noise because the event signals have occurred at discrete times can be removed from the detection process. As a result of removal of event signals that are highly likely to be noise from the detection process, the speed of the arithmetic can be increased. Accordingly, the process resources in the signal processing circuit 200 can be saved.

It is to be noted that, in the present embodiment, an upper limit can be imposed on the number of event signals held in the BEB 223, and an event signal that has a large difference from the process time or the time of the latest event signal can be deleted or ignored, as previously explained. Besides these configurations or in place of these configurations, when a result of representing a distribution of times of event signals with use of a Gaussian mixture model is used, a time series of occurrence of movements of a subject can be reflected, and an unnecessary event signal can be removed from the detection process with higher precision.

In still another example using a Gaussian mixture model, the detector 224 may detect a line segment in accordance with a result representing the positions x, y and times t of event signals in a block by a three-dimensional normal distribution with use of a Gaussian mixture model. In this case, a cluster identified in the Gaussian mixture model has three unique vectors. Among these vectors, a unique vector that has the smallest angle formed with respect to the time axis (the axis of the time t) is projected onto the x-y plane, is divided by a movement time, and then is determined as a speed vector. With such a configuration, when time-series line segment detection is performed, a speed vector of a detected line segment can be obtained with a small arithmetic amount, compared to a case where, for example, line segments are individually identified at a plurality of times.

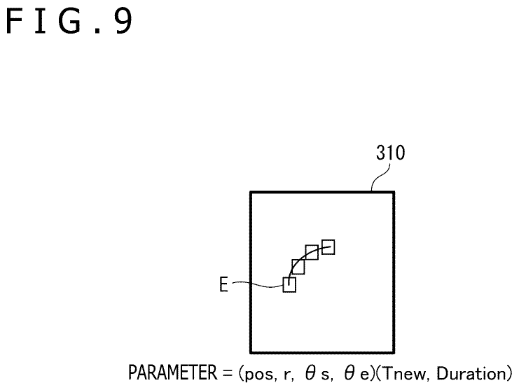

FIG. 9 is a diagram depicting another example of detecting a figure formed by a set of positions of event signals. In the depicted example, a detector that is disposed in addition to or in place of the detector 224 depicted in FIG. 1 detects a circular arc from a set of the positions x, y of event signals E. In this case, the detector outputs parameters including a center position (pos), a radius (r), a start point angle (θs), and an end point angle (θe) of the circle, a latest event time (Tnew), and event duration time (Duration). In such a manner, as the intra-block positional relation among event signals generated in the block 310, a curved line such as a circular arc or an elliptical arc formed by a set of the positions of the event signals may be detected. Also in a case where a curved line is detected, it is likely that a distribution of events in the block 310 is biased toward a certain direction. Therefore, by the techniques having been explained with reference to FIG. 4 to FIG. 7, the influence of noise can be reduced.

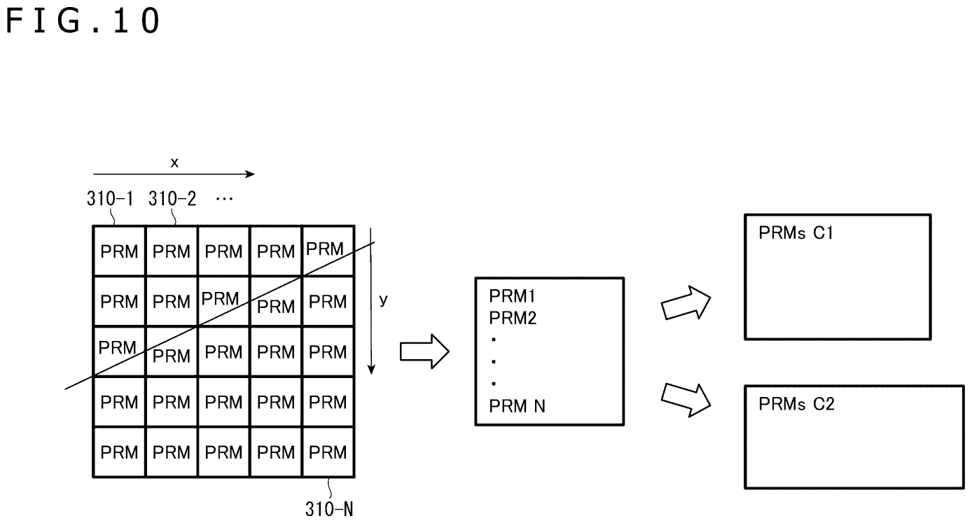

FIG. 10 is a diagram for illustrating a process example using parameters indicating the positional relation among event signals in a block. As explained above, in the present embodiment, parameters (PRM) are outputted in respective blocks 310 which are split sections of the detection region of the EVS 100. By way of example, PRM1 (A, t) outputted at the time t in the block 310-1 and PRM1 (A, t−Δt) outputted at a previous time (earlier than the time t by Δt) in the same block 310-1 are compared with each other, and movement or rotation of a line segment detected in the block 310-1 can thus be calculated. In the post-process 226, on the basis of a result of such calculation, PRM 1, PRM 2, . . . . PRM N respectively outputted in the blocks 310-1, 310-2, . . . , 310-N are classified into clusters according to whether movement directions or rotation directions thereof are close to each other. Accordingly, clusters (event line segment clusters) PRMs C1 and PRMs C2 of parameters, in each of which it is inferred that a common line segment is detected, can be identified. On the basis of parameters classified into the same event line segment cluster, such arithmetic as affine transformation can be performed for a figure extending over a plurality of blocks. It is to be noted that a straight line extending over a plurality of blocks is depicted in FIG. 10, but, for example, a curved line as a set of line segments having different gradients in respective blocks can be handled in a similar manner.

In the present embodiment, the above processing result can be used for detection of a movement of a subject, three-dimensional shape matching on a subject, a recognizer process using machine learning, or the like in the post-process 226, for example. The parameters 225 are lighter than bitmap data of event signals, for example, and further, a line segment represented by the parameters 225 can be handled as a precise figure free from constraints of the spatial resolution of the EVS 100. Accordingly, such arithmetic as affine transformation of a figure detected from event signals can be performed at high speed and with high precision.

### REFERENCE SIGNS LIST

100: EVS
200: Signal processing circuit
210: Memory
221: Buffer
222: Splitter
223: Block event buffer (BEB)
224: Line segment detector
225: Block line parameter (BLP)
226: Post-process
310: Block
310-1, 310-2, 310A, 310B: Block

1. A signal processing circuit that processes an event signal generated by an event-based vision sensor, the signal processing circuit comprising:
a memory for storing a program code; and
a processor for executing an operation in accordance with the program code, wherein the operation includes detecting, in each block of blocks which are split sections of a detection region of the event-based vision sensor, a relation between positions of event signals included in the block in accordance with a result representing a distribution of at least the positions of the event signals or generation times of the event signals with a use of a Gaussian mixture model.

2. The signal processing circuit according to claim 1, wherein detecting the relation includes identifying a figure formed by a set of the positions of the event signals in a cluster identified in the Gaussian mixture model that represents the positions of the event signals in the cluster by a two-dimensional normal distribution.

3. The signal processing circuit according to claim 2, wherein identifying the figure includes, in a case where the distribution of the positions of the event signals in the cluster has a directivity, calculating a parameter representing a line segment that is formed by a set of the positions of the event signals in the cluster, in accordance with a parameter of the cluster.

4. The signal processing circuit according to claim 1, wherein detecting the relation includes identifying a figure that is formed by a set of the positions of the event signals in a cluster identified in the Gaussian mixture model that represents the generation times of the event signals by a one-dimensional normal distribution.

5. The signal processing circuit according to claim 4, wherein identifying the figure includes, in a case where a difference between a center of the distribution of the generation times of the event signals in the cluster and a process time or a time of a latest event signal is greater than a threshold, refraining from using the event signals in the cluster for identification of the figure.

6. The signal processing circuit according to claim 4, wherein identifying the figure includes, in a case where a length of distribution time of the event signals in the cluster is greater than a threshold, refraining from using the event signals in the cluster for identification of the figure.

7. The signal processing circuit according to claim 2, wherein identifying the figure includes identifying, with regard to the event signals in the cluster, a parameter representing the figure from a set of the positions of the event signals in the cluster with use of Hough transform.

8. The signal processing circuit according to claim 1, wherein detecting the relation includes, with regard to event signals in a cluster identified in the Gaussian mixture model that represents the positions of the event signals and the generation times of the event signals by a three-dimensional normal distribution, identifying a figure that is formed by a set of the positions of the event signals in a time-series manner.

9. A signal processing method for processing an event signal generated by an event-based vision sensor, the method comprising:
through an operation that is executed by a processor in accordance with program code stored in a memory, detecting a relation between positions of event signals generated in each block of blocks which are split sections of a detection region of the event-based vision sensor, in accordance with a result representing a distribution of at least the positions of the event signals or generation times of the event signals in the block with a use of a Gaussian mixture model.

10. (canceled)

11. The signal processing method according to claim 9, wherein detecting the relation includes identifying a figure formed by a set of the positions of the event signals in a cluster identified in the Gaussian mixture model that represents the positions of the event signals in the cluster by a two-dimensional normal distribution.

12. The signal processing method according to claim 11, wherein identifying the figure includes, in a case where the distribution of the positions of the event signals in the cluster has a directivity, calculating a parameter representing a line segment that is formed by a set of the positions of the event signals in the cluster, in accordance with a parameter of the cluster.

13. The signal processing method according to claim 9, wherein detecting the relation includes identifying a figure that is formed by a set of the positions of the event signals in a cluster identified in the Gaussian mixture model that represents the generation times of the event signals by a one-dimensional normal distribution.

14. The signal processing method according to claim 13, wherein identifying the figure includes, in a case where a difference between a center of the distribution of the generation times of the event signals in the cluster and a process time or a time of a latest event signal is greater than a threshold, refraining from using the event signals in the cluster for identification of the figure.

15. The signal processing method according to claim 13, wherein identifying the figure includes, in a case where a length of distribution time of the event signals in the cluster is greater than a threshold, refraining from using the event signals in the cluster for identification of the figure.

16. The signal processing method according to claim 11, wherein identifying the figure includes identifying, with regard to the event signals in the cluster, a parameter representing the figure from a set of the positions of the event signals in the cluster with use of Hough transform.

17. The signal processing method according to claim 9 wherein detecting the relation includes, with regard to event signals in a cluster identified in the Gaussian mixture model that represents the positions of the event signals and the generation times of the event signals by a three-dimensional normal distribution, identifying a figure that is formed by a set of the positions of the event signals in a time-series manner.

18. A non-transitory, computer-readable medium storing one or more instructions executable by a computer system to perform one or more operations for processing an event signal generated by an event-based vision sensor, comprising:
detecting a relation between positions of event signals generated in each block of blocks which are split sections of a detection region of the event-based vision sensor, in accordance with a result representing a distribution of at least the positions of the event signals or generation times of the event signals in the block with a use of a Gaussian mixture model.

19. The non-transitory, computer-readable medium according to claim 18, wherein detecting the relation includes identifying a figure formed by a set of the positions of the event signals in a cluster identified in the Gaussian mixture model that represents the positions of the event signals in the cluster by a two-dimensional normal distribution.

20. The non-transitory, computer-readable medium according to claim 19, wherein identifying the figure includes, in a case where the distribution of the positions of the event signals in the cluster has a directivity, calculating a parameter representing a line segment that is formed by a set of the positions of the event signals in the cluster, in accordance with a parameter of the cluster.

21. The non-transitory, computer-readable medium according to claim 18, wherein detecting the relation includes identifying a figure that is formed by a set of the positions of the event signals in a cluster identified in the Gaussian mixture model that represents the generation times of the event signals by a one-dimensional normal distribution.
